(19) United States
(12) Patent Application Publication
(10) Pub. No.: US 2011/0084906 A1
(43) Pub. Date: Apr. 14, 2011

(54) MULTI-MODE MOUSE WITH CHANGEABLE SIZE

(75) Inventor: Chun-Che Wu, Taipei (TW)

(73) Assignee: PRIMAX ELECTRONICS LTD., Taipei (TW)

(21) Appl. No.: 12/695,028

(22) Filed: Jan. 27, 2010

(30) Foreign Application Priority Data
Oct. 9, 2009 (TW) 098134285

(51) Int. Cl. G06F 3/033

(52) U.S. Cl. 345/163

(57) ABSTRACT

A multi-mode mouse with a changeable size is provided. The multi-mode mouse includes a mouse body and a battery compartment. The multi-mode mouse includes a connecting wire to be connected with a computer, and a wireless signal emitter for generating a wireless signal. When the battery compartment is disconnected from the mouse body, the multi-mode mouse has a first size. When the battery compartment is connected with the mouse body, the multi-mode mouse has a second size. The first size is smaller than the second size. The multi-mode mouse is suitably used by different users having different sizes of palms. In addition, the multi-mode mouse could be operated in a wired mode, a wireless mode or a charging mode.

### FIELD OF THE INVENTION

The present invention relates to a multi-mode mouse, and more particularly to a multi-mode mouse with a changeable size.

### BACKGROUND OF THE INVENTION

With increasing development of scientific technologies, multimedia products and computers become essential in our daily lives. In the computer systems, input devices play important roles for communicating the computer and the user. The common input devices of the computer systems include for example mice, keyboards or trackballs. Among these input devices, mice are the most prevailing because they are very easy-to-use. When a mouse is held on the palm of a user's hand, the user may move the mouse to control movement of the cursor shown on the computer screen. In addition, by operating the click buttons of the mouse device, the user may select a desired item on the function menu of the browsing frame or execute a corresponding function.

Hereinafter, the configuration and function of a mouse will be illustrated by referring to a wheel mouse. FIG. 1 is a schematic perspective view illustrating a conventional wheel mouse. The wheel mouse 1 is in communication with a computer (not shown). The wheel mouse 1 comprises a mouse body 10, a left click button 11, a right click button 12 and a scroll wheel 13. The mouse body 10 is used for supporting a user's palm. By operating the left click button 11 or the right click button 12, a control signal is issued to the computer such that the computer executes a corresponding instruction. By rotating the scroll wheel 13 forwardly or backwardly, the graphic-based window or the web page shown on the computer screen may be scrolled in the vertical direction so as to facilitate the user to browse web pages or documents. The basic functions of the wheel mouse have been described above.

Recently, a variety of mice with diverse functions have been introduced into the market. For example, wheel mice having 4D-directional scroll wheels, wireless mice with no physical connecting wires or ergonomic mice designed according to the shapes of human's palms become more and more prevailing.

Generally, since the palms of different users have different sizes, the users may select feasible mice according to their palms' sizes. For example, a small-size and portable slim-type mouse is suitably held by a small palm of a female user. Since the male user has a bigger palm than the female user, the slim-type mouse is not feasible to the male user.

Therefore, there is a need of providing a mouse with a changeable size so as to meet the requirements of different users.

### SUMMARY OF THE INVENTION

The present invention provides a multi-mode mouse with a changeable size.

In accordance with an aspect of the present invention, there is provided a multi-mode mouse with a changeable size. The multi-mode mouse is in communication with a computer, and operated in a wireless mode, a wired mode or a charging mode. The multi-mode mouse includes a mouse body and a battery compartment. The mouse body includes a connecting wire, a wireless signal emitter, an electric connecting member and a first positioning mechanism. The connecting wire is used for transmitting electricity and signals. When the multi-mode mouse is operated in the wired mode or the charging mode, the connected wire is protruded from a front end of the mouse body to be connected with the computer such that electricity is transmitted from the computer to the mouse body through the connecting wire. When the multi-mode mouse is operated in the wireless mode, the connecting wire is accommodated within the mouse body. The wireless signal emitter is disposed within the mouse body for generating a wireless signal. The electric connecting member is arranged at a rear end of the mouse body. The first positioning mechanism is disposed at the rear end of the mouse body. The battery compartment is used for providing electricity to the mouse body. The battery compartment includes an electric contact member and a second positioning mechanism. The electric contact member is arranged at a front end of the battery compartment. When the battery compartment is connected with the mouse body, the electric contact member is in contact with the electric connecting member, so that electricity is transmitted from the battery compartment to the mouse body. The second positioning mechanism is arranged at the front end of the battery compartment. When the front end of the battery compartment is in contact with the rear end of the mouse body, the second positioning mechanism is engaged with the first positioning mechanism to facilitate connecting the battery compartment with the mouse body. When the multi-mode mouse is operated in the wired mode, the mouse body is disconnected from the battery compartment such that the multi-mode mouse has a first size. When the multi-mode mouse is operated in the wireless mode or the charging mode, the mouse body is connected with the battery compartment such that the multi-mode mouse has a second size, wherein the first size is smaller than the second size.

In an embodiment, the multi-mode mouse further includes a wireless signal receiver, which is connected with the computer for receiving the wireless signal.

In an embodiment, the mouse body further includes a mode-switching element for switching the multi-mode mouse from the wireless mode to the wired mode, or from the wired mode to the wireless mode.

In an embodiment, when the multi-mode mouse is switched from the wired mode to the wireless mode, the wireless signal emitter is enabled to generate the wireless signal.

In an embodiment, the mouse body further includes a winding reel for winding the connecting wire such that the connecting wire is stored within the mouse body.

In an embodiment, the electric connecting member includes an electric connecting member positive electrode and an electric connecting member negative electrode, and the electric contact member includes an electric contact member positive electrode and an electric contact member negative electrode. When the electric connecting member comprises is connected with the electric contact member, the electric connecting member positive electrode and the electric connecting member negative electrode are respectively in contact with the electric contact member positive electrode and the electric contact member negative electrode to transmit electricity.

In an embodiment, the first positioning mechanism includes at least one first magnetic element, and the second positioning mechanism includes at least one second magnetic element.

In an embodiment, the first positioning mechanism includes at least one fixing post, and the second positioning mechanism includes at least one indentation.

In an embodiment, the connecting wire further includes a connecting part to be connected with the computer so as to transmit electricity and signals.

In an embodiment, the mouse body further comprises a receiving recess for accommodating the connecting part.

In an embodiment, the connecting part is a universal serial bus (USB) connector.

In an embodiment, the mouse body further includes an electricity indicator for indicating residual electricity of the battery compartment.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a conventional wheel mouse;

FIG. 2 is a schematic view illustrating a multi-mode mouse according to an embodiment of the present invention;

FIG. 3 is a schematic view illustrating the operations of the multi-mode mouse in the wired mode according to the present invention;

FIG. 4 is a schematic view illustrating the multi-mode mouse of FIG. 2 and taken in another viewpoint;

FIG. 5 is a schematic view illustrating the operations of the multi-mode mouse in the wireless mode according to the present invention;

FIG. 6 is a schematic view illustrating the operations of the multi-mode mouse in the wireless mode according to the present invention; and

FIG. 7 is a schematic view illustrating the operations of the multi-mode mouse in the charging mode according to the present invention.

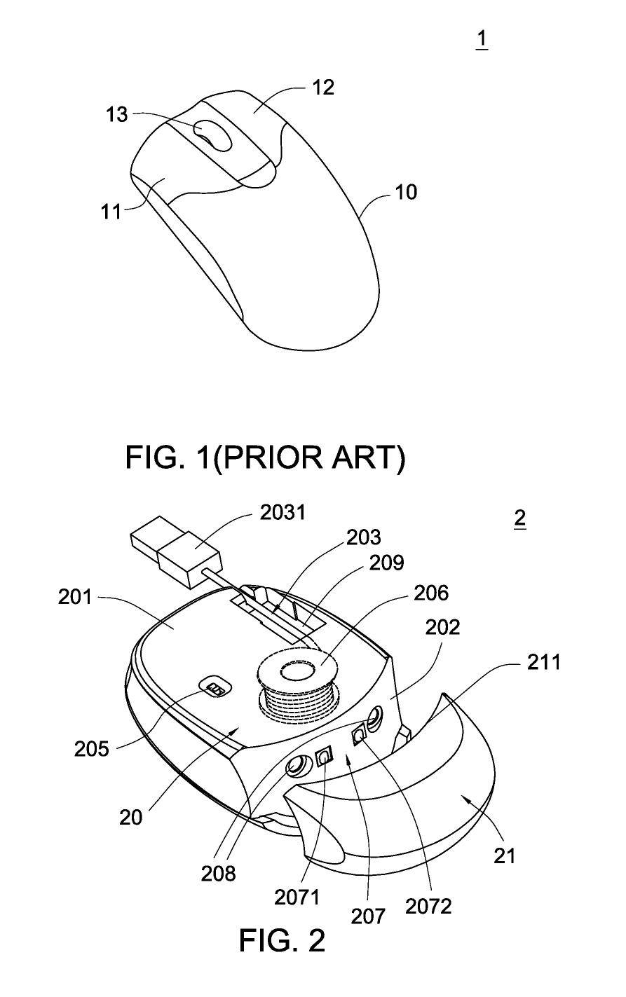

### DETAILED DESCRIPTION OF THE PREFERRED EMBODIMENT

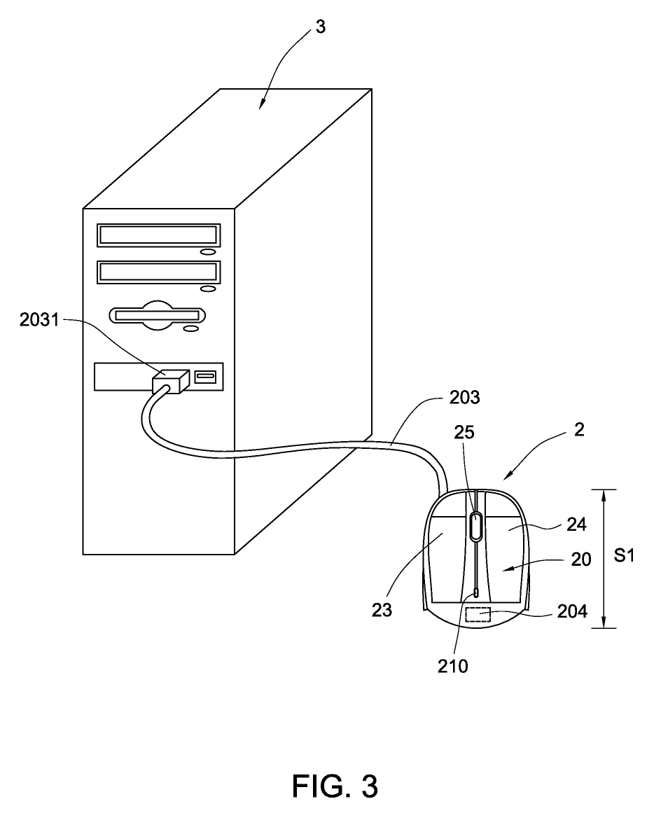

For obviating the drawbacks encountered from the prior art, the present invention provides a multi-mode mouse. FIG. 2 is a schematic view illustrating a multi-mode mouse according to an embodiment of the present invention. In FIG. 2, the bottom portion of the multi-mode mouse 2 is shown. The multi-mode mouse 2 comprises a mouse body 20 and a battery compartment 21. The mouse body 20 comprises a connecting wire 203, a wireless signal emitter 204 (see FIG. 3), a mode-switching element 205, a winding reel 206, an electric connecting member 207, a first positioning mechanism 208 and a receiving recess 209.

The connecting wire 203 has a connecting part 2031. An example of the connecting part 2031 includes a universal serial bus (USB) connector. By means of the mode-switching element 205, the multi-mode mouse 2 could be switched from a wireless mode to a wired mode, or from the wired mode to the wireless mode. The winding reel 206 is disposed within the mouse body 20 for winding the connecting wire 203 such that the connecting wire 203 is stored within the mouse body 20. The receiving recess 209 is disposed in the bottom portion of the mouse body 20. As such, when the multi-mode mouse 2 is operated in the wireless mode, the connecting part 2031 of the connecting wire 203 could be accommodated within the receiving recess 209. The electric connecting member 207 is arranged at the rear side of the mouse body 20 (i.e. the mouse body rear side 202). The efficacy of the electric connecting member 207 and the first positioning mechanism 208 will be illustrated later.

Hereinafter, the operations of the multi-mode mouse 2 in the wired mode will be illustrated with reference to FIG. 3. FIG. 3 is a schematic view illustrating the operations of the multi-mode mouse in the wired mode according to the present invention. As shown in FIG. 3, the multi-mode mouse 2 is in communication with a computer 3 via the connecting wire 203. The connecting wire 203 is protruded out of a front side of the mouse body 20 (i.e. the mouse body front side 201). The mouse body 20 comprises a wireless signal emitter 204 for generating a wireless signal. The multi-mode mouse 2 further comprises a left click button 23, a right click button 24 and a scroll wheel 25. By operating the left click button 23, the right click button 24 and the scroll wheel 25, corresponding control signals are generated. When the multi-mode mouse 2 is switched to the wired mode by adjusting the mode-switching element 205, the wireless signal emitter 204 is disabled. The control signals generated in response to the operations of the user are transmitted to the computer 3 through the connecting wire 203. In addition, the electricity required for operating the multi-mode mouse 2 is transmitted from the computer 3 to the multi-mode mouse 2 through the connecting wire 203. When the multi-mode mouse 2 is in the wired mode, the multi-mode mouse 2 has a first size S1 (see FIG. 3).

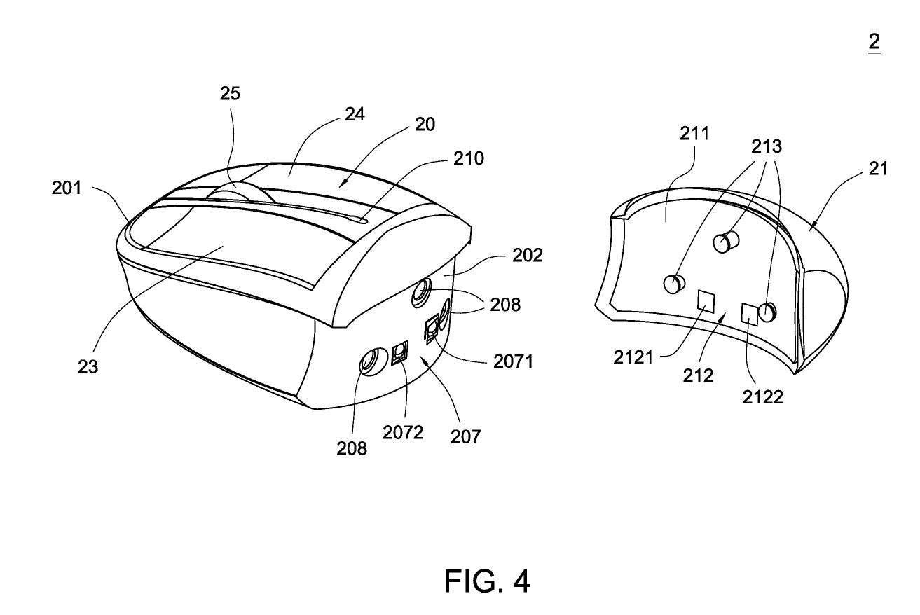

FIG. 4 is a schematic view illustrating the multi-mode mouse of FIG. 2 and taken in another viewpoint. As shown in FIG. 4, the electric connecting member 207 and the first positioning mechanism 208 are arranged at the mouse body rear side 202 of the mouse body 20. The electric connecting member 207 comprises an electric connecting member positive electrode 2071 and an electric connecting member negative electrode 2072. Moreover, as shown in FIG. 4, an electric contact member 212 and a second positioning mechanism 213 are arranged at a front side of the battery compartment 21 (i.e. the battery compartment front side 211). The electric contact member 212 comprises an electric contact member positive electrode 2121 and an electric contact member negative electrode 2122.

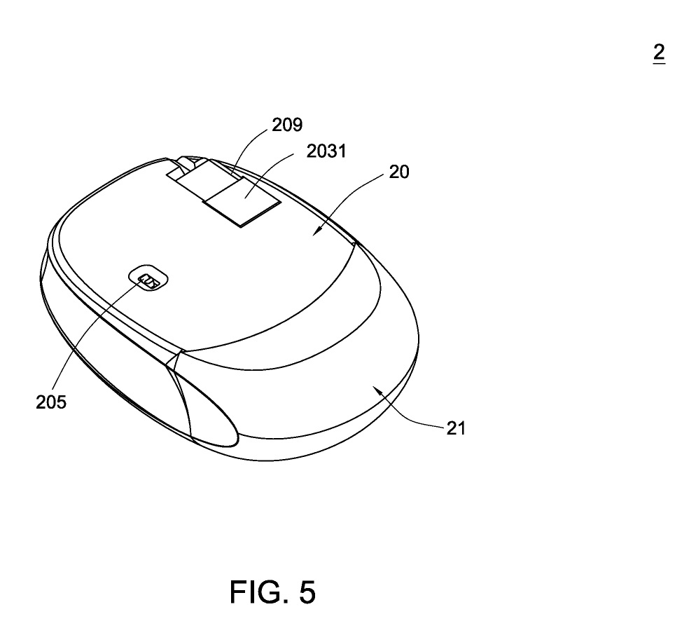

FIG. 5 is a schematic view illustrating the operations of the multi-mode mouse in the wireless mode according to the present invention. Please refer to FIGS. 4 and 5. When the multi-mode mouse 2 is switched to the wireless mode by adjusting the mode-switching element 205, the connecting wire 203 is stored within the mouse body 20 by the winding reel 206 such that the connecting part 2031 is accommodated within the receiving recess 209. Since the connecting wire 203 for transmitting electricity and signals is disconnected from the computer 3, the multi-mode mouse 2 is no longer powered by the computer 3. For powering the multi-mode mouse 2, the mouse body 20 needs to be connected with the battery compartment 21. After the mouse body 20 is connected with the battery compartment 21, the electric connecting member 207 at the mouse body rear side 202 is in contact with the electric contact member 212 at the battery compartment front side 211. In particular, the electric connecting member positive electrode 2071 and the electric connecting member negative electrode 2072 of the electric connecting member 207 are in contact with the electric contact member positive electrode 2121 and the electric contact member negative electrode 2122 of the electric contact member 212, respectively.

At the same time, the first positioning mechanism 208 at the mouse body rear side 202 is coupled with the second positioning mechanism 213 at the battery compartment front side 211, thereby facilitating connecting the mouse body 20 with the battery compartment 21. In an embodiment, the first positioning mechanism 208 includes at least one first magnetic element, and the second positioning mechanism 213 includes at least one second magnetic element. When the first positioning mechanism 208 and the second positioning mechanism 213 are contacted with each other, the first positioning mechanism 208 and the second positioning mechanism 213 are magnetically attracted by each other, so that the mouse body 20 is securely connected with the battery compartment 21. In some embodiments, the first positioning mechanism 208 includes at least one fixing post (not shown), and the second positioning mechanism 213 includes at least one indentation (not shown) for accommodating the corresponding fixing post. After the mouse body 20 is connected with the battery compartment 21, the resulting structure of the multi-mode mouse 2 is shown in FIG. 5. Meanwhile, the multi-mode mouse 2 is operated in the wireless mode.

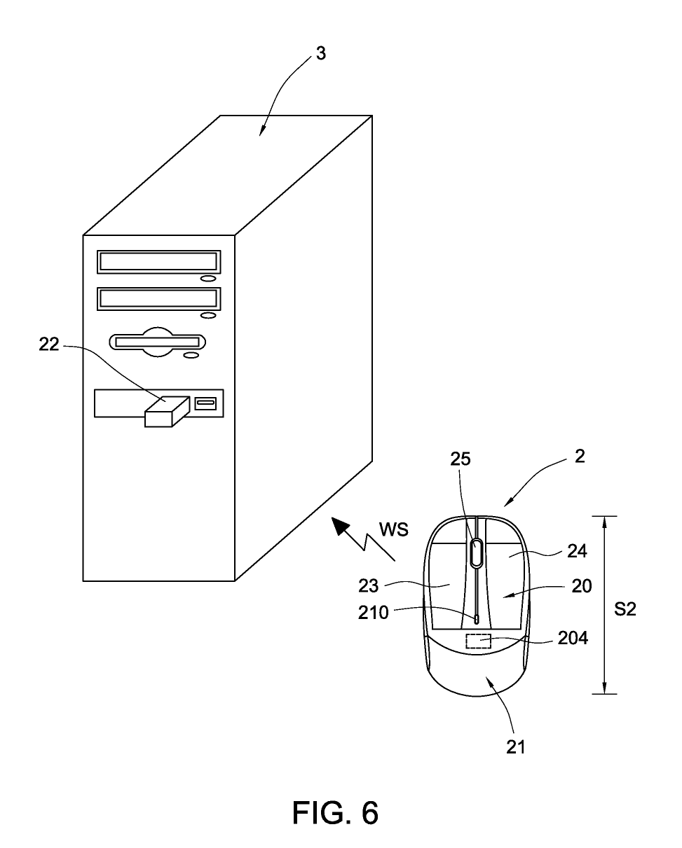

FIG. 6 is a schematic view illustrating the operations of the multi-mode mouse in the wireless mode according to the present invention. As shown in FIG. 6, a wireless signal receiver 22 is connected to the computer 3 for receiving a wireless signal WS that is generated by the wireless signal emitter 204 of the multi-mode mouse 2, so that the computer 3 executes an instruction corresponding to the wireless signal WS. When the multi-mode mouse 2 is switched to the wireless mode by adjusting the mode-switching element 205 (see FIG. 3) and the battery compartment 21 is connected with the mouse body 20, the wireless signal emitter 204 is enabled. During operations of the multi-mode mouse 2, the wireless signal WS that generated by the wireless signal emitter 204 will be transmitted to the computer 3. In addition, when the multi-mode mouse 2 is in the wireless mode, the multi-mode mouse 2 has a second size S2 (see FIG. 6).

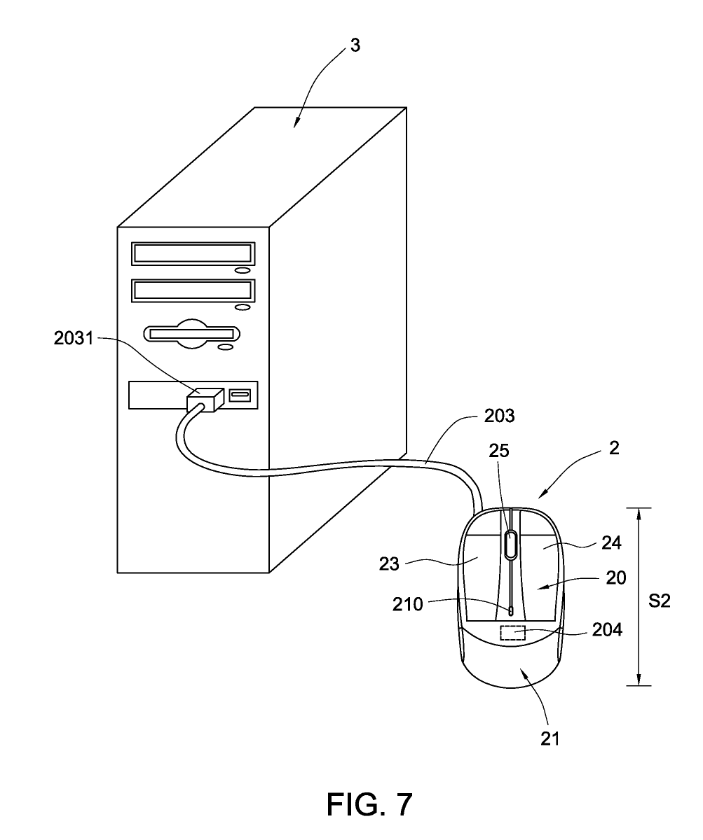

In some embodiments, the mouse body 20 of the multi-mode mouse 2 further comprises an electricity indicator 210 for indicating the residual electricity of the battery compartment 21. After the multi-mode mouse 2 has been operated in the wireless mode for a certain period, the user may realize the insufficient residual electricity of the battery compartment 21 by means of the electricity indicator 210. Meanwhile, the multi-mode mouse 2 could be switched from the wireless mode to the wired mode by adjusting the mode-switching element 205, and then the connecting wire 203 is pulled out of the mouse body 20 to be connected to the computer 3 (see FIG. 7). Meanwhile, electricity is transmitted from the computer 3 to the multi-mode mouse 2 through the connecting wire 203, and then transmitted to the battery compartment 21 through the electric connecting member 207 and the electric contact member 212 to charge the battery compartment 21. Under this circumstance, the multi-mode mouse 2 is operated in a charging mode. When the multi-mode mouse 2 is in the charging mode, the wireless signal emitter 204 is enabled and thus electricity and signals are transmitted through the connecting wire 203.

From the above description, it is found that the multi-mode mouse 2 could be operated in different modes according to the user's requirements. For example, in a case that the user uses the computer 3 at his or her seat, the multi-mode mouse 2 could be operated in the wired mode. In another case that the computer 3 is a notebook computer to be carried to a conference room to participate in a meeting, the multi-mode mouse 2 could be operated in the wireless mode. Whereas, if the multi-mode mouse 2 is operated in the wireless mode and the residual electricity is insufficient, the multi-mode mouse 2 could be switched to the charging mode in order to continuously work. Moreover, as shown in FIGS. 3, 6 and 7, when the multi-mode mouse 2 is operated in the wired mode, the multi-mode mouse 2 has a first size S1; and when the multi-mode mouse 2 is operated in the wireless mode or the charging mode, the multi-mode mouse 2 has a second size S2, wherein the first size S1 is smaller than the second size S2. For complying with diversified users, the size of the multi-mode mouse 2 of the present invention is changeable as required. For example, when the multi-mode mouse 2 has the first size S1, the mouse is suitably used by the user having a relatively smaller palm. Whereas, when the multi-mode mouse 2 has the second size S2, the mouse is suitably used by the user having a relatively bigger palm.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-mode mouse with a changeable size, said multi-mode mouse being communication with a computer, and operated in a wireless mode, a wired mode or a charging mode, said multi-mode mouse comprising:
a mouse body comprising:
a connecting wire for transmitting electricity and signals, wherein when said multi-mode mouse is operated in said wired mode or said charging mode, said connected wire is protruded from a front end of said mouse body to be connected with said computer such that electricity is transmitted from said computer to said mouse body through said connecting wire, and when said multi-mode mouse is operated in said wireless mode, said connecting wire is accommodated within said mouse body;
a wireless signal emitter disposed within said mouse body for generating a wireless signal;
an electric connecting member arranged at a rear end of said mouse body; and
a first positioning mechanism disposed at said rear end of said mouse body; and
a battery compartment for providing electricity to said mouse body, said battery compartment comprising:
an electric contact member arranged at a front end of said battery compartment, wherein when said battery compartment is connected with said mouse body, said electric contact member is in contact with said electric connecting member, so that electricity is transmitted from said battery compartment to said mouse body; and
a second positioning mechanism arranged at said front end of said battery compartment, wherein when said front end of said battery compartment is in contact with said rear end of said mouse body, said second positioning mechanism is engaged with said first positioning mechanism to facilitate connecting said battery compartment with said mouse body,
wherein when said multi-mode mouse is operated in said wired mode, said mouse body is disconnected from said battery compartment such that said multi-mode mouse has a first size, and when said multi-mode mouse is operated in said wireless mode or said charging mode, said mouse body is connected with said battery compartment such that said multi-mode mouse has a second size, wherein said first size is smaller than said second size.

2. The multi-mode mouse according to claim 1 further comprising a wireless signal receiver, which is connected with said computer for receiving said wireless signal.

3. The multi-mode mouse according to claim 1 wherein said mouse body further comprises a mode-switching element for switching said multi-mode mouse from said wireless mode to said wired mode, or from said wired mode to said wireless mode.

4. The multi-mode mouse according to claim 3 wherein when said multi-mode mouse is switched from said wired mode to said wireless mode, said wireless signal emitter is enabled to generate said wireless signal.

5. The multi-mode mouse according to claim 1 wherein said mouse body further comprises a winding reel for winding said connecting wire such that said connecting wire is stored within said mouse body.

6. The multi-mode mouse according to claim 1 wherein said electric connecting member comprises an electric connecting member positive electrode and an electric connecting member negative electrode, and said electric contact member comprises an electric contact member positive electrode and an electric contact member negative electrode, wherein when said electric connecting member comprises is connected with said electric contact member, said electric connecting member positive electrode and said electric connecting member negative electrode are respectively in contact with said electric contact member positive electrode and said electric contact member negative electrode to transmit electricity.

7. The multi-mode mouse according to claim 1 wherein said first positioning mechanism includes at least one first magnetic element, and said second positioning mechanism includes at least one second magnetic element.

8. The multi-mode mouse according to claim 1 wherein said first positioning mechanism includes at least one fixing post, and said second positioning mechanism includes at least one indentation.

9. The multi-mode mouse according to claim 1 wherein said connecting wire further comprises a connecting part to be connected with said computer so as to transmit electricity and signals.

10. The multi-mode mouse according to claim 9 wherein said mouse body further comprises a receiving recess for accommodating said connecting part.

11. The multi-mode mouse according to claim 9 wherein said connecting part is a universal serial bus (USB) connector.

12. The multi-mode mouse according to claim 1 wherein said mouse body further comprises an electricity indicator for indicating residual electricity of said battery compartment.
